(19) United States
(12) Patent Application Publication
(10) Pub. No.: US 2007/0035174 A1
(43) Pub. Date: Feb. 15, 2007

(54) Skate board spinner wheels

(76) Inventor: Gabor Paulovits JR., San Leandro, CA (US)

Correspondence Address: QUINE INTELLECTUAL PROPERTY LAW GROUP, P.C., P O BOX 458, ALAMEDA, CA, 94501, US

(21) Appl. No.: 11/490,862

(22) Filed: Jul. 20, 2006

Related U.S. Application Data
(60) Provisional application No. 60/702,699, filed on Jul. 26, 2005.

(51) Int. Cl. A63C 17/22; B60B 7/04

(52) U.S. Cl. 301/37.25; 301/5.301

(57) ABSTRACT

This invention provides skateboard wheels and skate wheels having spinner hubcaps. The wheels have a wheel body and spinner hubcaps mated using a mounting device having a rotational mount that allows the hubcaps to spin independently from the main wheel body.

### CROSS-REFERENCE TO RELATED APPLICATIONS

This application claims priority to and benefit of a prior U.S. Provisional Application No. 60/702,699, Skate Board Spinner Wheels, by Gabor Paulovits, Jr., filed Jul. 26, 2005. The full disclosure of the prior application is incorporated herein by reference.

### FIELD OF THE INVENTION

The present invention is in the field of wheels and wheel covers for skates and skateboards. Independently spinning hubcaps are mounted, through a mounting device, to the body or axle of the wheel for visual effects and other benefits.

### BACKGROUND OF THE INVENTION

Various hubcaps have been designed for wheels of vehicles in which the cap can rotate independently from the wheel. These inventions can, enhance safety, benefit cooling of brakes, provide a display surface for advertisements, or just provide an eye-catching appearance.

In U.S. Pat. No. 2,997,344, Wheel Cover, to Whiteman, an inner hub is mounted, through a ball bearing set, to an outer hub. The inner hub is visible through openings in the outer hub and free to rotate independently from the outer hub. The outer hub is fixedly mounted to the wheel of an automobile. As the wheel turns, the inner hub can be seen moving independent of the outer hub for a visual display that is said to provide a visual safety signal to vehicles approaching from the sides of the vehicle.

In U.S. Pat. No. 2,954,629, Non-Rotatable Advertising Plate for a Motor Vehicle Hub Cap, to Matin, a plate is mounted, through a ball bearing set, on the outside of a hubcap, which in turn is mounted to a vehicle wheel. The plate includes a weight near one edge so that as the wheel and hubcap turn, the plate retains an orientation with the weighted edge down. This allows words or symbols printed on the outside of the plate to be viewed right side up while the vehicle is in motion.

In U.S. Pat. No. 2,762,469, Wheel Cover, to Lyon, a hubcap is rotatably mounted, through a ball bearing set, to a mounting bracket mounted to the axle. The hubcap includes vanes that interact with the air stream of the moving vehicle to cause the hubcap to spin. The spinning is said to promote air circulation through the wheel.

Independently spinning hubs are more rare in non-motorized vehicles. In Bicycle Wheel with Spinner Attachment, U.S. patent application Ser. No. 2005/0146201, by Cavazos, et al., an independently spinning spoke cover is mounted to the axle of a bicycle wheel, through a ball bearing assembly. This spoke cover does not cap the wheel hub. The spokes of the wheel can be visible through holes or slots in the cover to provide an interesting visual effect.

Hubcaps have been described for roller skate wheels and skate board wheels. In U.S. Pat. No. 4,363,502, Illuminative Skate Wheel, to Bakerman, lights mounted to the skate axle can be viewed through a clear hubcap mounted to the body of the skate wheel. The mounted lights do not spin, but are intermittently illuminated as electrical contacts are made during the spinning of the wheels. Various inventors have described skate wheel hubcaps that are mounted to the skate axles (not turning) or mounted to the skate wheel (turning with the wheel). For example, see hubcaps mounted to wheels by adhesives in Wheel Hub Cap for Skate Wheels, U.S. Pat. No. 3,883,180, to Kain, and wheel hubcaps pressed on to skate axles in Skate Wheel Cover, U.S. Pat. No. 4,511,182, to Birnbaum.

In view of the above, a need exists for a hubcap suitable for skate or skateboard wheels that can turn independently from the wheel. Current spinning wheel covers for motor vehicles have certain design aspects inappropriate or incompatible with use on skateboard wheels. It would be desirable to have rotatable hub covers with design features well suited to mounting on skateboard wheels. Benefits could be realized through the use of more simple and inexpensive alternative hubcap components for use in skateboard wheels. The present invention provides these and other features that will be apparent upon review of the following.

### SUMMARY OF THE INVENTION

The skateboard spinner wheels of the invention include spinner hubcaps rotationally mounted to a skateboard wheel. The wheel can include, e.g., a skateboard wheel body, and a hubcap rotatably mounted to the wheel body, wherein the hubcap can spin independently of the wheel body. Further, the present invention provides wheels for skateboards comprising: a wheel body configured for mounting on an axle of a skateboard, a mounting device affixed to the wheel body and having a rotational mount, and a hubcap rotatably mounted to the rotational mount, wherein the hubcap can rotate independently from the wheel body.

In preferred embodiments, the wheel body has a rolling surface with a diameter of about 2 inches and is made of polyurethane. The wheel body is typically mounted to a skateboard axle with, e.g., one or more 25 mm to 21 mm ball bearing sets or roller bearing sets seated in central axial recesses of the wheel body.

The mounting device can be affixed to the wheel body, e.g., with a press fit, an adhesive, a screw, mounting threads, or an expanding collet. In preferred embodiments the mounting device can include, e.g., a mounting plate with a central hole and configured as a flat disk, a concave disk, or a convex disk. In a particular embodiment, the mounting device rotational mount for the spinner hubcap includes a ball bearing set or roller bearing set. Alternately, the rotational mount specifically does not have a ball bearing set or roller bearing set. For example, a spinner hubcap can be rotatably mounted to freely spin on a pin projecting from the mounting device and inserted through a hole in the hubcap. In preferred embodiments, the pin has an outer diameter about 0.25 inches or less and a hole inner diameter at least 0.001 inches greater than the pin outer diameter.

The spinner hubcaps of the invention are typically substantially round disks with perforations and surface ornamentation. The hubcaps usually have an outer diameter less than about 2 inches and are typically made of a metal. The hubcaps can have one or more apertures or slits, e.g., to provide visual effects and to allow access to mounting connectors. Optionally, additional hubcaps can be mounted fixed to the skateboard axle.

The axis of rotation of the wheel body is usually substantially coaxial with the hubcap rotational axis. However, in certain embodiments, the hubcap center of mass is substantially offset from the rotational mount axis of rotation, e.g., to promote an upright orientation of the hubcap while the skateboard is in motion or stopped.

In a preferred embodiment, the wheel for skateboards comprises: a polyurethane wheel body with recesses to receive 21 mm bearing sets and configured for mounting on an axle of a skateboard. The mounting device includes a disk mounted to the wheel body with an adhesive or one or more screws. The spinner hubcap has a hole and the mounting device has a pin affixed to a backing disk so that, with the pin inserted through the hole, the hubcap can spin freely and independently from any turning of the wheel body.

In use, the spinner hubcap can spin freely relative to the wheel body to which it is mounted. However, some frictional resistance will exist on any rotational mount, thus generally tending to cause the hubcap to take on some of the angular momentum of the wheel body, absent external factors. In a typical set up, starting with the skateboard, wheel body and hubcap motionless, the wheel body will begin to turn as the rider propels the skateboard forward. There may be some lag, as a body at rest tends to remain at rest, but eventually angular momentum will be transferred from the turning wheel body to the hubcap through frictional resistance in the rotational mount mechanism. As the rider rolls along, the hubcap may eventually accelerate to turn at approximately the rotational speed of the wheel body. Should the rider stop the skateboard abruptly, the wheel body will stop, but the hubcap will continue spinning on the rotational mount, as a body in motion tends to remain in motion (absent some external factor, such as frictional resistance). Eventually, e.g., due to frictional resistance in the rotational mount, the hubcap will also slow to a stop. This incongruity between the wheel motion and hubcap motion can be an interesting and eye-catching visual phenomenon.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or biological systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a component” can include a combination of two or more components; reference to “a rider” can include two or more riders, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

The term “skateboard”, as used herein, refers to a recreational device comprising a low platform mounted over four wheels, and powered into motion by a,rider standing on the platform. Skateboards of the invention include sporting equipment, such as skateboards and roller skates well known and understood by those skilled in the art.

A “mounting device” as referred to herein, is a device that can be affixed to a skateboard wheel body and comprising a rotational mount for a hubcap. The rotational mount can be any that allows the hubcap to rotate independently in at least one direction, relative to the wheel body. For example, the rotational mount can comprise a ball bearing set or roller bearing set with one bearing race attached to the affixed part of the mounting device and the other race attached to the hubcap. Alternately, the rotational mount can comprise a shaft freely rotatable in a bushing, wherein if the hubcap is attached to the bushing, the shaft is attached to the affixed mount part; or if the hubcap is attached to the shaft, the bushing is attached to the affixed mount part, so that the hubcap can rotate relative to the wheel body. In a preferred embodiment, the rotational mount comprises a pin in a hole, wherein if the hubcap has the hole, the affixed part has a pin inserted through the hubcap hole so it can spin freely on the pin; or, if the affixed part has the hole, the hubcap has a pin inserted through the hole.

### BRIEF DESCRIPTION OF THE DRAWINGS

FIG. 1 shows a schematic diagram of an exemplary skateboard spinner wheel with a hubcap mounted through a ball bearing set rotational mount.

FIG. 2 shows a schematic diagram of a spinner wheel with the hubcap pin and hole rotational mount.

FIG. 3 shows a schematic diagram of a spinner wheel mounted to a skateboard axle.

FIG. 4 shows aspects of a wheel body.

FIG. 5 shows schematic diagrams of exemplary spinner hubcaps.

### DETAILED DESCRIPTION

Spinner wheels of the invention are suitable for installation on typical skateboards and skates. The wheels include hubcaps that are eye catching and can help identify the skateboard. The hubcaps can spin independently from the body of the wheel, e.g., not turning when the wheel body begins to roll and continuing to turn after the wheel body has stopped. This can provide an attention getting display to those used to seeing typical old-style hubcaps which are fixed to the wheel or axle.

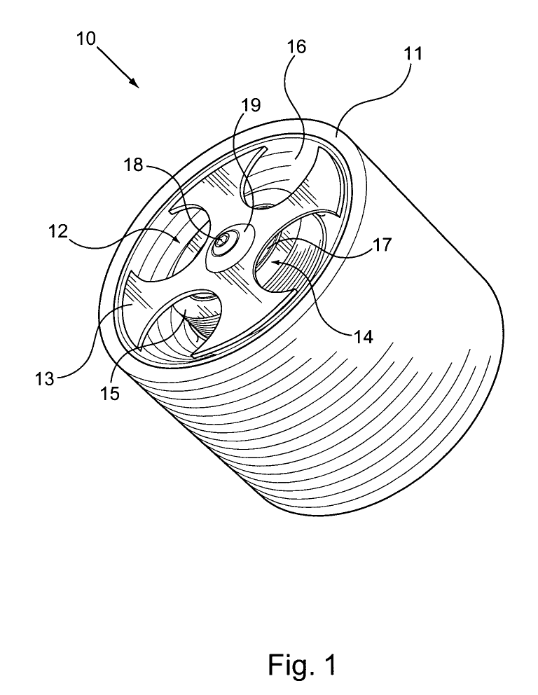

The spinner skateboard wheels can include a mounting device fixedly mounted to the body of the wheel and providing a rotational mount for the hubcap. For example, as shown in FIG. 1, the wheel 10, can include wheel body 11, with a mounting device 12 fixed to the wheel body. A hubcap 13 is rotationally mounted to the mounting device so that it can spin independently of the wheel body. The mounting device, in this case, includes a ball bearing set 14 with the outer race 15 press fit into concave mounting plate 16. The inner ball bearing race 17 is attached to retainer bolt 18 that retains the hubcap 13 in a rotational mount along with retainer washer 19. The mounting plate is fixed to the wheel body with an adhesive ring, not shown. Because the hubcap is rotatably mounted to the wheel body through the mounting device, it can turn independently from turning of the wheel body.

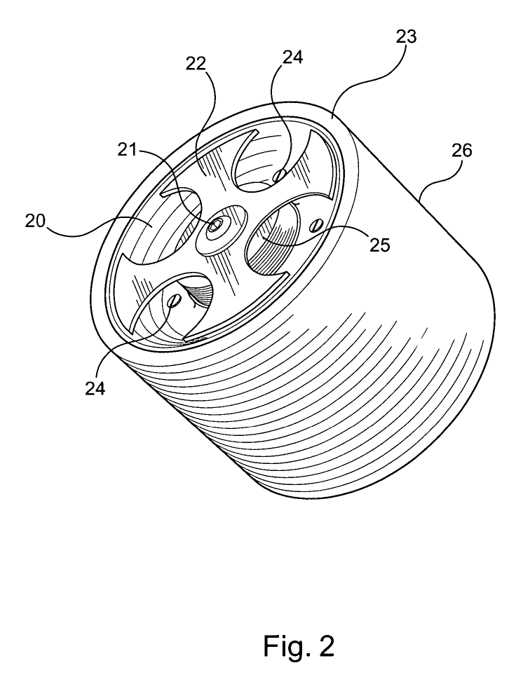

In another embodiment, the roller bearing can be replaced with an arrangement wherein the hubcap spins on a pin protruding from the mounting device. For example, a mounting device can simply comprise a mounting plate 20 with a central pin 21 extending out, as shown in FIG. 2. The hubcap 22 can be rotatably mounted on the pin so that it can turn independently from the turning to the wheel body 23. The mounting plate can be fixed to the wheel body using mounting screws 24. The hubcap can be spaced from the mounting plate by backing disk 25.

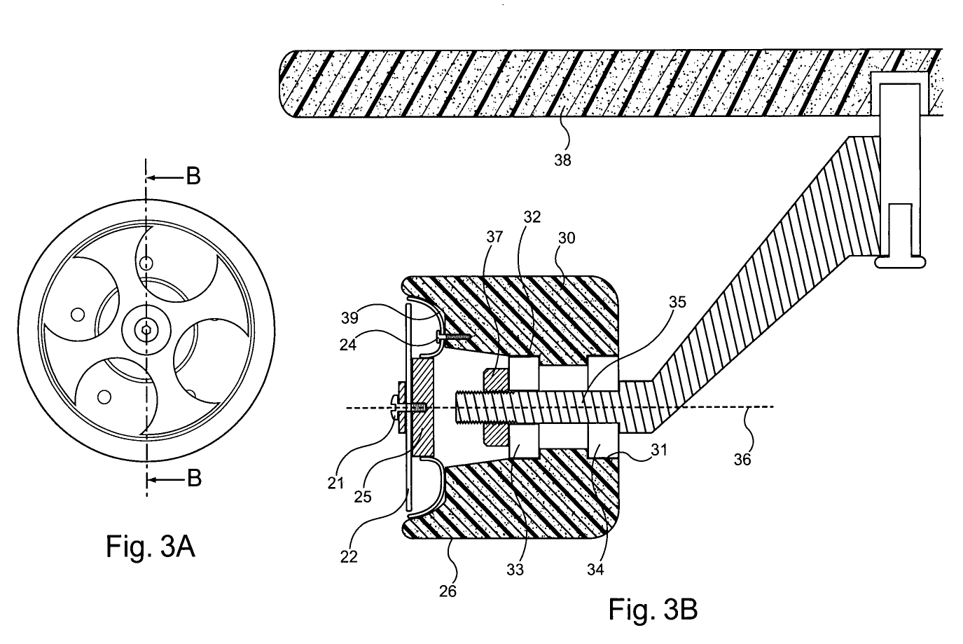

The wheels can be mounted to skates and skateboards in the fashion of typical skateboard wheels. For example, as shown in FIG. 3, the wheel body 30 can have an inner recess 31 and outer recess 32 to receive an outer bearing set 33 and inner bearing set 34. A skateboard axle 35 can run through the center axis 36 of the wheel and bearings, with the whole assembly being held together by axle nut 37.

In use, a skateboard rider can have one foot on the skateboard platform 38 and push off with the other foot to propel the skateboard forward and causing the wheel body to turn about the central axis. Due to conservation of momentum, the hubcap 22 will at first remain substantially without rotational motion about central pin 21. However, because backing disk 25 and the central pin 21 turn at the rate of the wheel body 30 and are in frictional surface contact with the hubcap 22, the hubcap will eventually begin to spin the same direction as the wheel body. Then, should the skateboard suddenly stop, the wheel body will stop turning, but the angular momentum of the spinning hub cap will allow it to continue spinning for some time.

The present invention can provide many benefits to the owner of the skateboard. The hubcap function can protect the bearings form dirt and damage from intruding objects. The unique hubcaps and hubcap designs can help uniquely identify the skateboard. The spinning hubcap can be designed with materials and perforations that create a pleasing sound while in motion. The incongruous motion (or lack thereof) between the wheel body and hubcap can be interesting, eye-catching and appealing.

Wheel Bodies

The wheel body of the invention can be, e.g., a standard skateboard wheel or a wheel configured for certain embodiments of the invention. For example, the wheel of the invention can be a standard wheel modified with the application of a mounting device and rotationally mounted hubcap. Alternately, the side surface 39 of wheel body 30 can be recessed, e.g., to allow mounting of the hubcap flush with the outer rolling surface of the wheel body. Optionally, the wheel body side surface can be convex, protruding out, e.g., so that the mounting device and hubcap are projected out from the wheel body.

The wheel body can be fabricated as a single piece of material, or can be a composite. The wheel body can be, e.g., a single piece of injection molded polyurethane. Optionally, the wheel body can be a composite of a softer frictional polyurethane or rubber outer rolling surface 26 over an inner core of harder honeycombed plastic material. The rolling surface can provide a smooth ride with enhanced traction while the inner core can be light but strong for interactions with mounting hardware. The wheel body can be made from, e.g., polyurethane, polypropylene, block copolymers, rubber, polycarbonate, nylon, carbon composites, ceramics, metals, and the like. In a preferred embodiment, the core is manufactured separately by injection molding with a hard plastic (e.g., polyethylene or acetyl), then the rolling surface material, typically polyurethane, is cast over the core.

Wheel bodies provide surfaces and/or fittings for fixed mounting of the mounting device. Typically, the outside surface (e.g., the surface generally perpendicular to the center axis and visible looking from the side of a skateboard to which they may be mounted) of the wheel body is configured to cooperate with the mounting device to reliably fix the mounting device to the wheel body. For example, the outer surface can have a generally concave surface into which a matching mounting plate fits. The mounting plate can be press fitted to remain securely in place. Optionally, the mounting plate can be fixed to the wheel body with an adhesive, or connectors, such as, e.g., screws, nails, bolts, rivets, etc. In certain embodiments, the outer surface is flat or convex, e.g., with suitably adapted corresponding mounting plates.

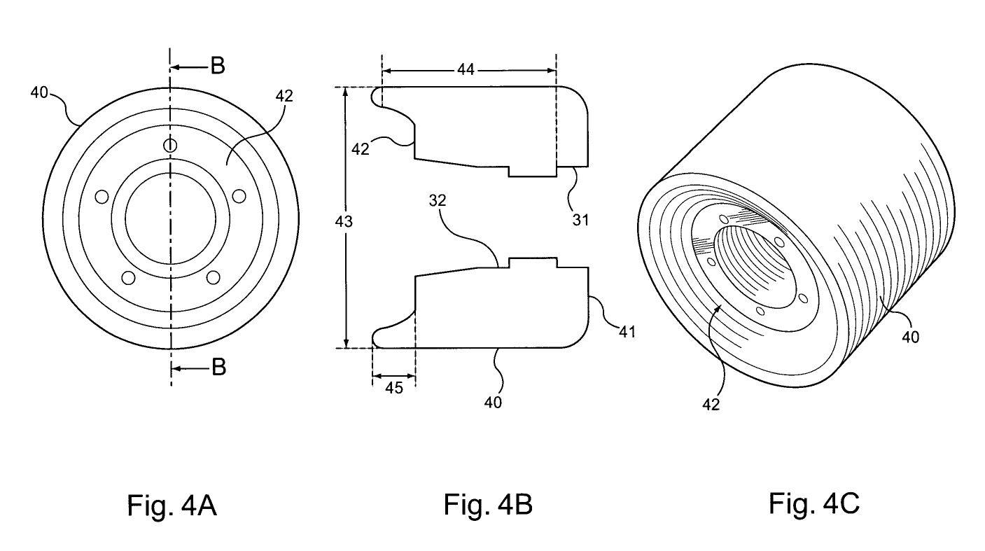

Wheel bodies are typically cylindrical with a substantially flat, concave or convex outer surface, as described above. The wheel bodies can be standard or modified skate or skateboard wheels. The opposing inner end surface is most commonly substantially flat. In some embodiments, e.g., where the wheels are to be mounted on in-line skates, the inner and outer surfaces can be mirror images in sagittal cross section. As shown generally in FIG. 4, the wheel body can include rolling surface 40, inner surface 41, and outer surface 42. The rolling surface diameter 43 can range, e.g., from about 4 inches to about 1 inch, from about 3 inches to about 1.5 inches, less than about 2.5 inches or about 2 inches. The rolling surface width 44 can range from about 3 inches to less than 0.5 inches, from about 2 inches to about 1 inch, or about 1.5 inches. The inner and outer bearing recesses are typically about 21 mm in diameter, but this can vary. In a preferred embodiment, the outer surface is concave and recessed a distance 45 from about 1 inch to about 0.1 inch, from about 0.5 inches to about 0.25 inches, or about 0.35 inches, e.g., to allow recessed mounting of the mounting device and hubcap.

Mounting Devices

A mounting device provides attachment of a hubcap to a wheel body through a rotational mount, e.g., so the hubcap can spin at a different rate and/or in a different direction than the wheel body. Mounting devices generally include a fixed mount configured to attach fixedly to a particular wheel body, and a rotational mount onto which a hubcap can be turnably attached.

In many embodiments, the fixed mount includes a mounting plate adapted to make functional contact with the outer surface of the wheel body. For example, if the outer surface is flat, the mounting plate is typically flat. If the outer surface is concave, the mounting plate can be concave; if the outer surface is convex, the mounting plate can be convex; etc. The outer surface can have complex shapes, such as a narrowing outer edge, allowing the mounting plate to be press-fit into the outer surface. The wheel body can include inner or outer threads so the mounting plate with complimentary threads can be screwed into or onto the wheel body. The back surface of the mounting plate can be shaped for close contact with the outer surface of the wheel body so effective use of adhesives or tape can be achieved. Various connectors can be used to mount the mounting plate to the wheel body. For example, bolts, screws, studs nuts, hook and loop fasteners, nails, rivets, and the like can be used to hold the mounting plate to the outer surface of the wheel body. In preferred embodiments, the mounting device is removably mounted, e.g., for easy access to the axle nut. For example, the mounting plate can have holes aligned with screw holes in the wheel body so that the mounting plate can be attached with screws.

The mounting plate can have an ornamented outer surface, e.g., to enhance the visual appeal of the wheel. The mounting plate can be colored, e.g., to aid in identification of the skateboard and to enhance contrast between the mounting plate and hubcap. The mounting plate can have perforations or slits to increase contrast behind the hubcap and allow the wheel color to show through. In some embodiments, the outer surface of the mounting plate can have visual patterns (such as expanding spirals of radial sections with changing colors) that can interact with a spinning hubcap to provide interesting visual effects.

The fixed mount to the wheel body does not have to be a mounting plate. The mounting device can include, e.g., a wire frame or cylindrical structure fixed to the wheel body. Optionally, the fixed mount of the mounting device can be a part of the wheel body, e.g., injection molded along with the wheel body.

The rotational mount portion of the mounting device can be any that can attach to a hubcap while allowing it to spin at a rate, or in a direction, different from the wheel body. The hubcap can spin while retained in a rotational mount comprising a peripheral track around the circumference of the hubcap outer edge. In preferred embodiments the hubcap rotates at a central axis attachment point. For example, the hubcap can have a central hole large enough to accommodate a pin projecting from the fixed mount. Optionally, the rotational mount can include various bearings and/or bushings, as described above.

Pin and hole type rotational mounts can have various advantages over ball bearing or bushing type mounts for skateboard spinner wheels of the invention. Because of the small scale of skateboard wheels, the loads on the rotational mount are low. The precision of mounting the hub caps does not have to be high because angular deflections from the spinning axis cause relatively small linear deflections at the hubcap edge. Because the radius of the hubcaps is small, strain on the rotational mount from lateral forces on the edge of the hubcap are not severely leveraged (i.e., the lever arm is small). Therefore, a simple pin and hole rotational mount can be used in skateboard spinner wheels without the problems, e.g., of wear and instability that would result in larger scale wheels. Additional benefits of the pin and hole design are simplicity of manufacture and assembly, low cost, reduced sensitivity of dirt and wear, and low weight.

The “pins” of a pin and hole rotational mount can be, e.g., a rod, preferably cylindrical, projecting from the fixed mount. The pin can be a threaded stud projecting from the fixed mount, going through a hole in the hubcap and capturing the hubcap with an end nut. The pin can be a screw inserted through the hubcap hole and screwed into a threaded hole in the fixed mount. The pin can be a rivet projecting through the hubcap hole from the fixed mount and capturing the hubcap by crimping or hammering the rivet head. The pin can be a pin or nail inserted through the hubcap hole and embedded into the fixed mount, the hubcap captured by the pin head larger than the hubcap hole. The pin can be a hollow tube and the hubcap captured by flaring out the end of the pin. The pins can have a diameter ranging from about 0.5 inches to less than about 0.05 inches, from about 0.4 inches to about 0.1 inches, about 0.3 inches to about 0.2 inches, or about 0.25 inches. The difference in pin outer diameter and hole inner diameter can range, e.g., from less than about 0.001 inches to more than about 0.1 inches, from about 0.005 inches to about 0.01 inches; with larger clearances generally more suitable with larger pins. In a preferred embodiment, the pin has a 0.25 inch diameter and the clearance between the pin and hole is about 0.001 inches.

In other aspects, the pin and hole rotational mount can include a backing disk and/or a retaining washer. The fixed mount can include a backing disk to support the pin and to help keep the hubcap aligned perpendicular to the spinning axis of the wheel. The retaining washer can help prevent the hubcap from slipping off the pin and also can help with hubcap alignment.

Hubcaps

The hubcaps can be rotatably mounted to the wheel so they can spin at a different speed and/or in a different direction compared to the body of the wheel. The hubcaps are generally visibly patterned in some fashion so their spinning rate is readily apparent to viewers, e.g., looking at the side of the skateboard. In preferred aspects, the hubcaps can be patterned metal disks rotationally mounted to the wheel body with minimal rotational friction.

Hubcaps can be mounted to cover the hub of an axle. The hubcap can partly or completely cover the end of a skateboard axle independently or in combination with the mounting devices of the invention. For example, a hubcap welded on one side to a rotational mount can cover the hub without the rotational mount being visible from the side view. The same can be true, e.g., where the rotational mount is a pin extending from the hub cap into a hole in the rotational mount, as described above. In many embodiments, the hubcap covers the axle hub, in part or in whole, in combination, e.g., with fittings of the rotational device visible, e.g., where they pass through a central hole in the hubcap.

The hubcaps can be made of any appropriate solid material. For example, the hubcaps can be made of a plastic, wood, ceramic, or a composite. Preferably, the hubcaps are made from a metal, such as, e.g., aluminum, iron, steel, titanium, copper, silver, gold, and/or the like. The hubcaps can be fabricated, e.g., by cutting or stamping from a sheet of material.

Hubcaps are often disks with a generally circular shape. The disks often have a central hole adapted for mounting to the rotational mount of the mounting device, as described above. The hole is usually centered on the disk center of mass, e.g., so that the disk does not have a preferred orientation at rest or vibrate significantly when spinning. In other embodiments, the hubcaps can be intentionally mounted at a hole that is not near the center of mass. The hubcaps can have a flat, concave, and/or convex topography.

The hubcaps can have a diameter no more than the diameter of the wheel body or only a small proportion of the wheel body diameter. For example, the hubcaps can range in diameter from more than about 4 inches to less than about 0.5 inches, from about 3 inches to about 1 inch, from about 2.5 inches to about 1.5 inches, or about 2 inches. The hubcaps can range in thickness from more than about 0.25 inches to less than about 0.01 inch, from about 0.1 inch to about 0.025 inches, or about 0.05 inches.

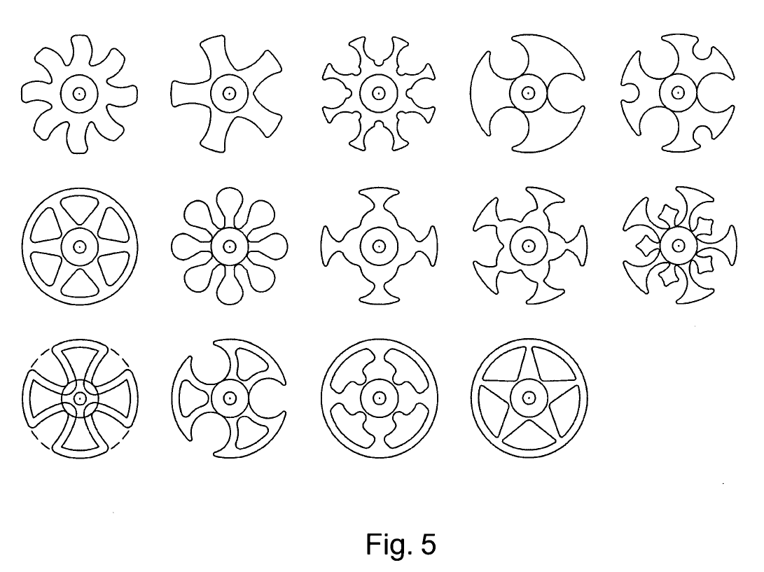

The hubcaps can have patterns on their outer surface. For example the surface can be textured, can be painted, and/or can be perforated. The texture in a metal hubcap can provide reflection angles that provide a sparkling effect as the hubcap turns in light. Two or more paint colors can contrast so the rate of turning is more apparent to viewers. The patterns can have radially progressive trends (such as spirals) to provide the illusion of a moving image. Perforations can add contrast and can allow surfaces behind the hubcap to be viewed. The perforations can also function to allow access to mounting device connectors for removal of the device. The perforations can be holes or slits of various shapes, e.g., as shown in FIG. 5. The perforations can be configured to interact with patterns, e.g., on a mounting plate, to provide visual effects, as described above.

Other Features

In some embodiments, the hubcaps are designed to be mounted on a rotational axis located at other than the center of mass of the hubcap. For example, a radially symmetrical hub cap can be mounted off center so that it has more weight on one side of the rotational axis than another, thus tending to promote a preferred vertical orientation, even when the wheel is spinning, or to always stop with the same vertical orientation, e.g., so that a symbol is recognizable or words can be easily read. Optionally, the hubcap can have a weight mounted close to one edge, so that edge tends to stay down.

Hubcaps can intentionally make noises. Provision of certain amounts of clearance between the hubcap and the rotational mount, backing disk, and/or retaining washer can result in a harmonic vibration as the wheel turns, resulting in a possibly desirable grinding or metallic sound. The hubcaps can make intermittent contact with other wheel parts to strike notes. The hubcaps can have orifices that emit a whistling sound at certain rotational speeds.

Mounting devices can be designed to allow one-way rotation of the hubcap. For example, a one-way ratchet mechanism in the rotational mount can force the hubcap to spin forward with the wheel body but allow the hubcap to continue spinning after the wheel body stops. Alternately, the ratchet mechanism can allow the hubcap to delay turning when the wheel body starts turning forward but stops a spinning hubcap when the wheel stops.

In an alternate configuration of the invention, a stator, fixed hubcap or freely spinning hubcap can be mounted to the axle of the skateboard. A stator can be, e.g., like hubcaps of the invention, but mounted motionless in front or behind a hubcap mounted to the wheel body. Depending on the relative radii and/or perforated patterns, their relative motion can provide various interesting visual patterns, such as, e.g., flickering, progressive motion illusions and the like. A freely spinning hubcap mounted to the skateboard axle can be made to spin, e.g., by the motion of air streams or frictional contact with other wheel parts. Hubcaps mounted to the skateboard axle could be viewed through perforations in the mounting device and/or outer hubcap.

### EXAMPLES

The following examples are offered to illustrate, but not to limit the claimed invention.

Ball Bearing Spinners

Skateboard wheels were prepared with ball bearing rotational mounts, as shown in FIG. 1. The wheel bodies were formed from an injection molded polyethylene core, which was in turn covered with a more frictional and resilient polyurethane rolling surface. The wheel body outer surface included donut-shaped concavity to interact with the selected mounting device.

The mounting device included a 21 mm ball bearing set pressed into a mounting plate stamped and die punched from aluminum sheet. An expandable collet, having a tapered internal bore, and an outer cylindrical surface just fitting inside the bearing inner race, was placed in the inner race. A nut having a threaded inner bore and tapered outer surface was inserted into the collet. A bolt with a retaining washer was inserted though a 1.5 inch diameter hubcap, then threaded into the nut inner bore. As the bolt was turned in the threads, the nut was pulled further into the collet so that the opposing tapered surfaces caused the collet to expand out and bind tightly in the bore of the bearing inner race. Thus, the hubcap was rotatably mounted to the mounting device.

The mounting device was fixed to the wheel body using a ring of adhesive tape. The back side of the mounting plate fit closely in the concavity of the wheel body outer surface. A 1.5 inch diameter ring of 3M VHB two-sided adhesive tape, with a 1 inch center hole, was stuck to the wheel body outer surface concavity. Then, the mounting plate of the mounting device was pressed into the concavity to be adhesively captured by the two-sided tape ring. Replacement of the mounting device required removal and replacement of the adhesive ring. Normally, the mounting device would be mounted to the wheel body after the wheel body has been mounted to a skateboard axle.

The hubcaps, thus mounted to the wheel body, could be spun independently from the wheel body. With a flick of the finger, the hubcap would spin smoothly, as inertia provides, before eventually stopping.

Pin Wheel Spinners

Skateboard wheels were prepared with pin and hole rotational mounts, as shown in FIGS. 2 and 3. As above, the wheel body core and rolling surface were separately injection molded. The wheel body outer surface included donut shaped concavity to interact with the selected mounting device.

The mounting device included a punched and formed aluminum mounting plate configured to fit closely to the wheel body concavity, and having a central hole into which an aluminum backing disk of slightly greater (0.02 inch) diameter was pressed. A button screw, with a retaining washer, was inserted through a hubcap center hole and screwed into a threaded hole at the center of the backing disk. Thus, the hubcap was rotatably mounted to the mounting device.

The mounting device was mounted to the wheel body using screws running through holes in the mounting plate and threaded into holes in the wheel body core. Access to the screws to tighten them with a screwdriver was provided past large openings in the hubcap. In cases where the hubcap has inadequate perforations, the mounting plate could be mounted to the wheel body before mounting the hubcap.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A wheel for skateboards, the wheel comprising:
a skateboard wheel body; and, a hubcap rotatably mounted to the wheel body;
wherein the hubcap can spin independently from the wheel body.

2. A wheel for skateboards, the wheel comprising:
a wheel body configured for mounting on an axle of a skateboard;
a mounting device affixed to the wheel body and comprising a rotational mount; and,
a hubcap rotatably mounted to the rotational mount;
wherein the hubcap can rotate independently from the wheel body.

3. The wheel of claim 2, further comprising a rolling surface comprising a diameter of about 2 inches or less.

4. The wheel of claim 2, wherein the wheel body further comprises a rolling surface comprising polyurethane.

5. The wheel of claim 2, wherein said wheel body mounting configuration comprises one or more ball bearing sets or roller bearing sets seated in the body, wherein the bearing sets comprise an outer race diameter of about 25 mm, 21 mm, or less.

6. The wheel of claim 2, wherein the mounting device is affixed to the wheel body with a press fit, an adhesive, a screw or an expanding collet.

7. The wheel of claim 2, wherein the mounting device comprises a mounting plate selected from the group consisting of: a flat disk, a concave disk, and a convex disk.

8. The wheel of claim 2, wherein the mounting device rotational mount comprises a ball bearing set or roller bearing set.

9. The wheel of claim 2, wherein the mounting device rotational mount does not comprise ball bearing set or roller bearing set.

10. The wheel of claim 2, wherein the mounting device rotational mount comprises a pin having an outer diameter and the hubcap comprises a hole with an inner diameter; wherein the hubcap can be rotatably mounted by inserting the pin through the hole.

11. The wheel of claim 10, wherein the pin outer diameter is about ¼ inch or less.

12. The wheel of claim 10, wherein the hole inner diameter is at least 0.001 inches greater than the pin outer diameter.

13. The wheel of claim 2, wherein the hubcap comprises an outer diameter of about 2 inches or less.

14. The wheel of claim 2, wherein the hubcap comprises one or more apertures or slits.

15. The wheel of claim 2, further comprising another hubcap mounted fixed to the skateboard axle.

16. The wheel of claim 2, wherein an axis of rotation of the hubcap is substantially coaxial with an axis of rotation of the wheel body.

17. The wheel of claim 2, wherein the hubcap center of mass is substantially offset from an axis of rotation of the rotational mount.

18. A wheel for skateboards, the wheel comprising:
a polyurethane wheel body comprising recesses to receive 21 mm bearing sets and configured for mounting on an axle of a skateboard;
a mounting device comprising a pin affixed to a mounting plate; and, a hubcap comprising a hole;
wherein the mounting plate is mounted to the wheel body with an adhesive or one or more screws, and the hubcap is mounted to the mounting device with the pin inserted through the hole;
whereby the hubcap can rotate on the pin independently from the body of the wheel.

19. The wheel of claim 18, wherein the pin is affixed to the mounting plate through a backing disk.
